(19) United States
(12) Patent Application Publication
(10) Pub. No.: US 2023/0381795 A1
(43) Pub. Date: Nov. 30, 2023

(54) Water Saving Motion Activated Showerhead Device

(71) Applicants: Jacob Hooper, Moroni, UT (US); Wyatt Nilsson, Moroni, UT (US)

(72) Inventors: Jacob Hooper, Moroni, UT (US); Wyatt Nilsson, Moroni, UT (US)

(21) Appl. No.: 17/827,863

(22) Filed: May 30, 2022

(51) Int. Cl. B05B 1/18; B05B 1/24; E03C 1/05; B05B 1/30

(52) U.S. Cl. CPC B05B 1/185; B05B 1/24; E03C 1/057; B05B 1/30

(57) ABSTRACT

A water saving motion activated showerhead device for saving water and energy and providing entertainment includes a housing, which is attachable to an inlet pipe of a shower enclosure so that a spray is generated by holes positioned in a front of the housing. A sensor detects motion in the shower enclosure in an area upon which the spray is directed and signals a valve to control a flow of water through the housing. A receiver receives an audio signal from an electronic device of a user and relays the audio signal to a speaker attached to the housing for broadcast. A heating module in the housing selectively heats the water that passes through the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to showerhead devices and more particularly pertains to a new showerhead device for saving water and energy and providing entertainment. The present invention discloses a showerhead device that heats water, broadcasts audio, and turns off a flow of water to the showerhead by means of a motion sensor and a valve.

### (2) Description of Related Art Including Information Disclosed Under 37 CFR 1.97 and 1.98

The prior art relates to showerhead devices. Prior art showerhead devices may comprise showerhead devices having motion sensors, speakers, or heating elements. The prior art does not teach a showerhead device comprising a motion sensor, a speaker, and a heating element.

### BRIEF SUMMARY OF THE INVENTION

An embodiment of the disclosure meets the needs presented above by generally comprising a housing, which has an aperture positioned in its rear. The aperture is internally threaded, thus the housing is configured for threaded attachment to an inlet pipe of a shower enclosure so that an interior space defined by the housing is in fluidic communication with the inlet pipe. A plurality of holes positioned in a front of the housing is configured to generate a spray from water that enters the interior space.

A power module, a valve, a heating module, and a receiver are attached to the housing and are positioned in the interior space. A sensor and a speaker are attached to the front of the housing. The sensor is operationally engaged to the power module and the valve. The valve, the heating module, the receiver, and the speaker are operationally engaged to the power module. The receiver is communicatively engaged to the speaker.

The sensor is configured to detect motion in the shower enclosure in an area upon which the spray is directed and to signal the valve. The valve is configured to control a flow of the water through the interior space by selectively opening and closing the 30 aperture. The receiver is configured to receive an audio signal from an electronic device of a user and to relay the audio signal to the speaker for broadcast. The heating module is configured to selectively heat the water that passes through the interior space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a water saving motion activated showerhead device according to an embodiment of the disclosure.

FIG. 2 is a bottom view of an embodiment of the disclosure.

FIG. 3 is a side view of an embodiment of the disclosure.

FIG. 4 is a cross-sectional view of an embodiment of the disclosure.

FIG. 5 is a block diagram of an embodiment of the disclosure.

### DETAILED DESCRIPTION OF THE INVENTION

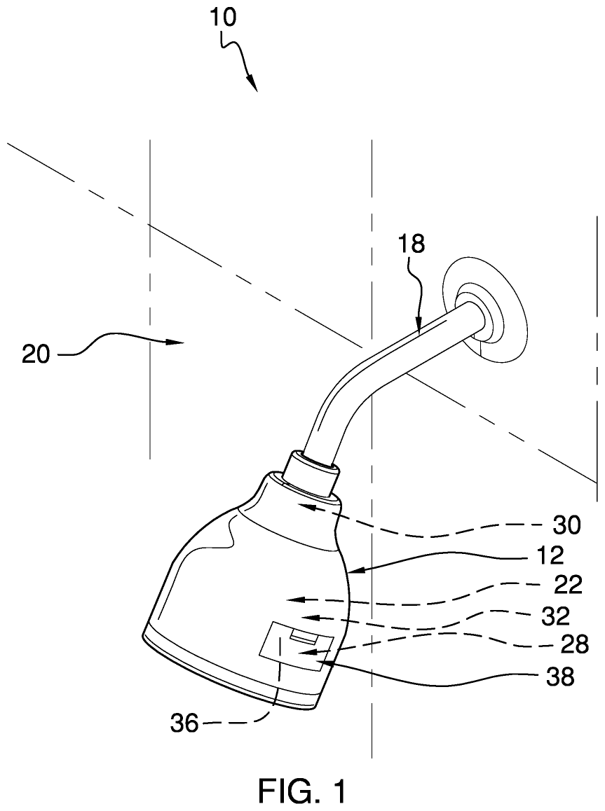

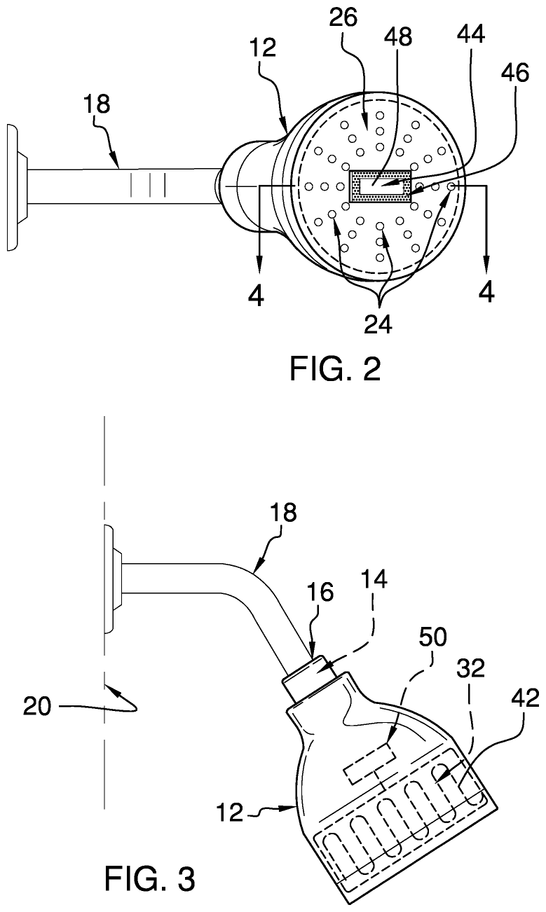

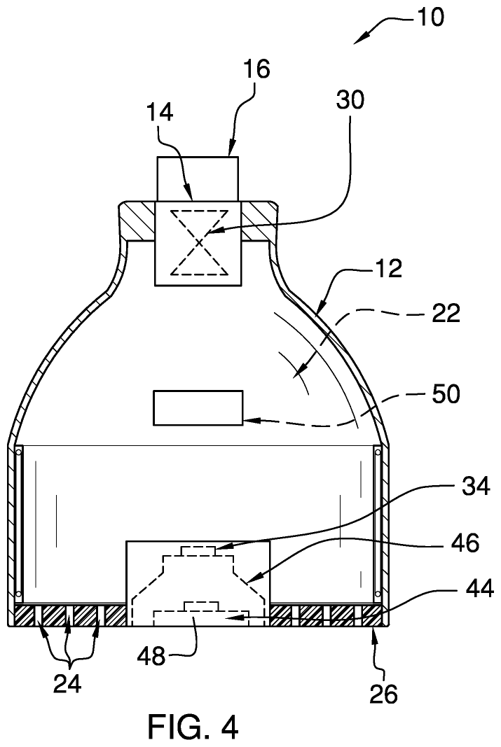

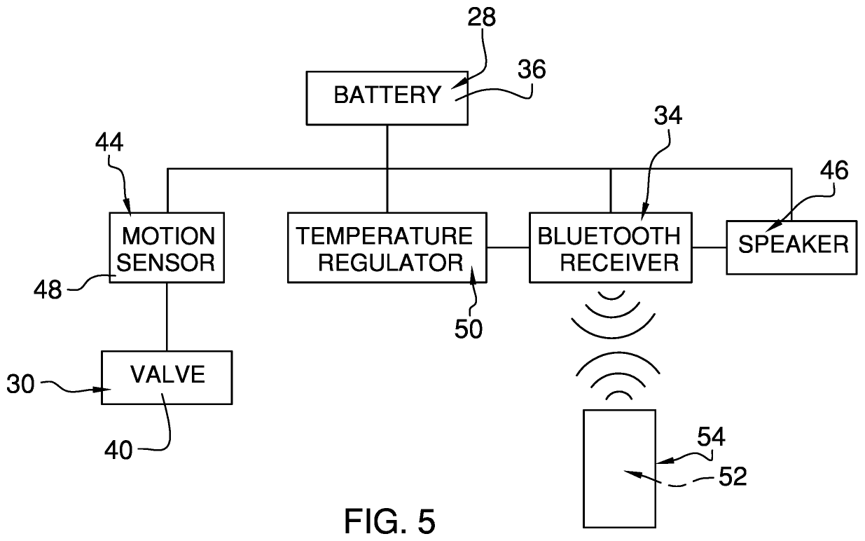

With reference now to the drawings, and in particular to FIGS. 1 through 5 thereof, a new showerhead device embodying the principles and concepts of an embodiment of the disclosure and generally designated by the reference numeral 10 will be described.

As best illustrated in FIGS. 1 through 5, the water saving motion activated showerhead device 10 generally comprises a housing 12, which has an aperture 14 positioned in its rear 16. The aperture 14 is internally threaded, thus the housing 12 is configured for threaded attachment to an inlet pipe 18 of a shower enclosure 20. Once attached, an interior space 22 defined by the housing 12 is in fluidic communication with the inlet pipe 18. A plurality of holes 24 is positioned in a front 26 of the housing 12 and is configured to generate a spray from water that enters the interior space 22.

A power module 28, a valve 30, a heating module 32, and a receiver 34 are attached to the housing 12 and are positioned in the interior space 22. As shown in FIG. 1, the power module 28 comprises a battery 36, which is accessible for replacement by means of a cover 38 that is detachable from the housing 12. The valve 30 comprises a solenoid valve 40. The heating module 32 comprises an immersion heater 42. The receiver 34 is configured to receive radio waves within a frequency range of between 2.400 and 2.485 GHz;

A sensor 44 and a speaker 46 are attached to the front 26 of the housing 12. The sensor 44 is operationally engaged to the power module 28 and the valve 30. The sensor 44 may comprise a passive infrared sensor 48, a microwave sensor, an ultrasonic sensor, or the like. The valve 30, the heating module 32, the receiver 34, and the speaker 46 are operationally engaged to the power module 28. The receiver 34 is communicatively engaged to the speaker 46.

The sensor 44 is configured to detect motion in the shower enclosure 20, in an area upon which the spray is directed, and to signal the valve 30. The valve 30 is configured to control a flow of the water through the interior space 22 by selectively opening and closing the aperture 14. The receiver 34 is configured to receive an audio signal from an electronic device 54 of a user and to relay the audio signal to the speaker 46 for broadcast. The heating module 32 is configured to selectively heat the water that passes through the interior space 22. The present invention is anticipated to save both water and energy compared to prior art showerhead devices.

A regulator 50 is attached to the housing 12, is positioned in the interior space 22, and is operationally engaged to the heating module 32 and the receiver 34. Programming code 52, which is selectively positionable on the electronic device 54 of the user, enables the electronic device 54 to set a temperature setpoint for the regulator 50 by signaling the regulator 50 via the receiver 34. The regulator 50 is enabled to adjust a heating output of the heating module 32 to regulate a temperature of the water passing through the interior space 22 to match the temperature setpoint.

In use, the inlet pipe 18 is threadedly inserted into the aperture 14 to attach the housing 12 to the inlet pipe 18. The electronic device 54 can be paired with the receiver 34, enabling the user to set the temperature setpoint so the regulator 50 adjusts the heating output of the immersion heater 42 to obtain water at a temperature desired by the user, and to broadcast an audio file over the speaker 46. The sensor 44 detects motion in the shower enclosure 20, in the area upon which the spray is directed, and signals the valve 30 to control a flow of water through the housing 12. Thus, as the user moves under the front 26 of the housing 12, the motion is sensed and the valve 30 is opened. As the user moves away from the housing 12, no motion will be detected by the sensor 44 and the valve 30 will be closed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water saving motion activated showerhead device comprising:
a housing;
an aperture positioned in a rear of the housing, the aperture being internally threaded, wherein the housing is configured for threaded attachment to an inlet pipe of a shower enclosure, such that an interior space defined by the housing is in fluidic communication with the inlet pipe;
a plurality of holes positioned in a front of the housing, wherein the holes are configured for generating a spray from water entering the interior space;
a power module attached to the housing and positioned in the interior space;
a valve attached to the housing and positioned in the interior space;
a sensor attached to the front of the housing and operationally engaged to the power module and the valve, the sensor being configured for detecting motion in the shower enclosure in an area upon which the spray is directed and for signaling the valve, wherein the valve is configured for controlling a flow of the water through the interior spaces by electively opening and closing the aperture;
a speaker attached to the front of the housing and operationally engaged to the power module;
a receiver attached to the housing, positioned in the interior space, and operationally engaged to the power module, the receiver being communicatively engaged to the speaker, wherein the receiver is configured for receiving an audio signal from an electronic device of a user and for relaying the audio signal to the speaker for broadcast; and
a heating module attached to the housing, positioned in the interior space, and operationally engaged to the power module, wherein is the heating module is configured for selectively heating water passing through the interior space.

2. The water saving motion activated showerhead device of claim 1, wherein the power module comprises a battery.

3. The water saving motion activated showerhead device of claim 1, wherein the valve comprises a solenoid valve.

4. The water saving motion activated showerhead device of claim 1, wherein the sensor comprises a passive infrared sensor.

5. The water saving motion activated showerhead device of claim 1, wherein the receiver is configured to receive radio waves within a frequency range of between 2.400 and 2.485 GHz.

6. The water saving motion activated showerhead device of claim 1, wherein the heating module comprises an immersion heater.

7. The water saving motion activated showerhead device of claim 1, further including:
a regulator attached to the housing, positioned in the interior space, and operationally engaged to the heating module and the receiver; and
programming code selectively positionable on the electronic device of the user enabling the electronic device for setting a temperature setpoint for the regulator by signaling the regulator via the receiver, enabling the regulator for adjusting a heating output of the heating module for regulating a temperature of the water passing through the interior space to match the temperature setpoint.

8. A water saving motion activated showerhead system comprising:
a shower enclosure having an inlet pipe;
a housing;
an aperture positioned in a rear of the housing, the aperture being internally threaded, the inlet pipe being threadedly inserted into the aperture, such that an interior space defined by the housing is in fluidic communication with the inlet pipe;
a plurality of holes positioned in a front of the housing, wherein the holes are configured for generating a spray from water entering the interior space;
a power module attached to the housing and positioned in the interior space;
a valve attached to the housing and positioned in the interior space;
a sensor attached to the front of the housing and operationally engaged to the power module and the valve, the sensor being configured for detecting motion in the shower enclosure in an area upon which the spray is directed and for signaling the valve, wherein the valve is configured for controlling a flow of the water through the interior spaces by electively opening and closing the aperture;
a speaker attached to the front of the housing and operationally engaged to the power module;
a receiver attached to the housing, positioned in the interior space, and operationally engaged to the power module, the receiver being communicatively engaged to the speaker, wherein the receiver is configured for receiving an audio signal from an electronic device of a user and for relaying the audio signal to the speaker for broadcast; and
a heating module attached to the housing, positioned in the interior space, and operationally engaged to the power module, wherein is the heating module is configured for selectively heating water passing through the interior space.

9. A water saving motion activated showerhead device comprising:
a housing;
an aperture positioned in a rear of the housing, the aperture being internally threaded, wherein the housing is configured for threaded attachment to an inlet pipe of a shower enclosure, such that an interior space defined by the housing is in fluidic communication with the inlet pipe;
a plurality of holes positioned in a front of the housing, wherein the holes are configured for generating a spray from water entering the interior space;
a power module attached to the housing and positioned in the interior space, the power module comprising a battery;
a valve attached to the housing and positioned in the interior space, the valve comprising a solenoid valve;
a sensor attached to the front of the housing and operationally engaged to the power module and the valve, the sensor being configured for detecting motion in the shower enclosure in an area upon which the spray is directed and for signaling the valve, wherein the valve is configured for controlling a flow of the water through the interior spaces by electively opening and closing the aperture, the sensor comprising a passive infrared sensor;
a speaker attached to the front of the housing and operationally engaged to the power module;
a receiver attached to the housing, positioned in the interior space, and operationally engaged to the power module, the receiver being communicatively engaged to the speaker, wherein the receiver is configured for receiving an audio signal from an electronic device of a user and for relaying the audio signal to the speaker for broadcast, the receiver being configured for receiving radio waves within a frequency range of between 2.400 and 2.485 GHz;
a heating module attached to the housing, positioned in the interior space, and operationally engaged to the power module, wherein is the heating module is configured for selectively heating water passing through the interior space, the heating module comprising an immersion heater;
a regulator attached to the housing, positioned in the interior space, and operationally engaged to the heating module and the receiver; and
programming code selectively positionable on the electronic device of the user enabling the electronic device for setting a temperature setpoint for the regulator by signaling the regulator via the receiver, enabling the regulator for adjusting a heating output of the heating module for regulating a temperature of the water passing through the interior space to match the temperature setpoint.
